(19) United States
(12) Patent Application Publication
(10) Pub. No.: US 2009/0282740 A1
(43) Pub. Date: Nov. 19, 2009

(54) Method and Apparatus to Facilitate Automatic Modification of Near Term Automated Movement Options as Regards a Movable Barrier

(76) Inventor: Shary Nassimi, Malibu, CA (US)

Correspondence Address: FITCH EVEN TABIN & FLANNERY, 120 SOUTH LASALLE STREET, SUITE 1600, CHICAGO, IL, 60603-3406, US

(21) Appl. No.: 12/119,880

(22) Filed: May 13, 2008

(51) Int. Cl. E05F 15/20

(52) U.S. Cl. 49/28; 49/31; 49/30

(57) ABSTRACT

A movable barrier operator (303) that is configured and arranged to selectively control movement of a barrier (302), upon detecting (101) motion of an object, can automatically modify (102) near term automated movement options for that barrier. As but one example in this regard, this can comprise automatically temporarily modifying planned movement of the barrier as was instigated by reception of a remote control command from a wireless remote control transmitter. By one approach, this can further comprise taking such action as function of the relative distance of the object from a given location. This can provide the basis, for example, of automatically modifying near term automated movement options of the barrier when the object is relatively far from the given location and not modifying such options when the object is relatively close to the given location.

### TECHNICAL FIELD

This invention relates generally to movable barrier operators.

### BACKGROUND

Movable barrier operators of various kinds are known in the art and include, for example, so-called garage door openers. Movable barrier operators typically serve to facilitate the automated movement of one or more corresponding movable barriers (such as, but not limited to single panel and segmented garage doors, rolling shutters, pivoting and sliding gates, barrier arms, and so forth). In many cases such movable barrier operators are responsive to a remotely sourced control signal (or signals) to institute such activity.

In some cases, the movement of a given movable barrier by a movable barrier operator may be based upon some impetus or plan other than, directly or indirectly, a specific real time input from an end user via their remote control transmitter. One illustrative example in this regard comprises the automated closing of a movable barrier following a given period of time after having moved that movable barrier to an opened position. This can comprise, for example, automatically closing a garage door five minutes after the garage door has been moved to an open position.

In some cases, such automated behavior comprises a default behavior as specified, for example, by the manufacturer of the movable barrier operator, an installer, or the like. In other cases, such automated behavior can be selectively enabled or disabled by the end user on an ad hoc basis. In either case, however, there can be instances when such automated behavior can lead to inconvenience or worse. Such a result can occur, for example, when the automated behavior conflicts in some manner with respect to a given set of circumstances as pertain to the movable barrier. As one simple illustrative example in this regard, it can potentially be inconvenient, at the least, to automatically close a movable barrier as described while a person is just then walking into the garage.

### BRIEF DESCRIPTION OF THE DRAWINGS

The above needs are at least partially met through provision of the method and apparatus to facilitate automatic modification of near term automated movement options as regards a movable barrier described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a top plan schematic view as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a movable barrier operator that is configured and arranged to selectively control movement of a barrier, upon detecting motion of an object at a time other than when the movable barrier operator is prepared to initiate selective imminent automated movement of the barrier, can automatically modify near term automated movement options for that barrier. As but one example in this regard, this can comprise automatically temporarily modifying planned movement of the barrier as was instigated by reception of a remote control command from a wireless remote control transmitter. By one approach, this can further comprise taking such action as function of the relative distance of the object from a given location. This can provide the basis, for example, of automatically modifying near term automated movement options of the barrier when the object is relatively far from the given location and not modifying such options when the object is relatively close to the given location (or vice versa as appropriate).

Those skilled in the art will appreciate that these teachings are readily implemented using existing technology and hence strongly supports the leveraging of known approaches and methodologies. These teachings are also highly scalable and are applicable in a wide variety of application settings. Similarly, these teachings will accommodate a wide variety of near term automated movement options as well as a wide variety of corresponding modifications to such options. Those skilled in the art will further appreciate that these teachings are readily implemented in a cost effective manner.

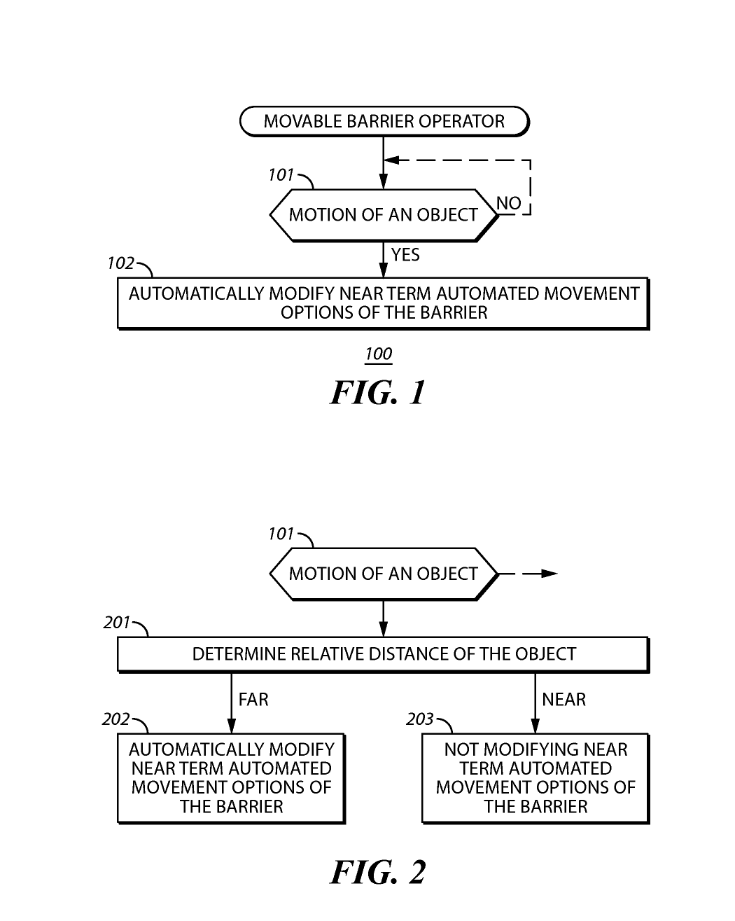

These and other benefits may become clearer upon making a thorough review and study of the following detailed description. Referring now to the drawings, and in particular to FIG. 1, an illustrative process that is compatible with many of these teachings will now be presented.

As referenced above, this process 100 can be carried out by a movable barrier operator that is configured and arranged to selectively control movement of a corresponding movable barrier. This can comprise, for example, a movable barrier operator that is capable of effecting automated movement of the movable barrier from a fully opened position to a fully closed position and vice versa.

This process 100 provides for first detecting 101 motion of an object. As used herein, this expression will be understood to refer to the detection of “motion” and not merely the detection of an object that is capable of motion. The “object,” in turn, can comprise an object having a size of relevance and interest such as a human child or human adult, a typical household pet such as a cat or a dog, a vehicle such as an automobile, and so forth. Smaller-sized objects, such as a blowing leaf, a rolling dust ball, a crawling mouse, and so forth may be ignored, if desired, for these purposes. Generally speaking, objects of concern are likely to be objects that are either capable of damaging and/or interfering with the movable barrier (or the movable barrier operator) and/or which are themselves capable of being damaged by the movable barrier and which damage is undesired.

These teachings are particularly specific with respect to when this step of detecting the object occurs. Although these teachings will accommodate detecting such an object at other times, this process 100 particularly provides for attempting to detect objects at a time other than when the movable barrier operator is prepared to initiate selective automated movement of the movable barrier. As one example in this regard, a movable barrier operator is “prepared to initiate selective automated movement” of a movable barrier when the operator has taken an action that will lead inexorably to such movement of the movable barrier absent some external catastrophic influence such as a removal of electrical power from a non-battery backed up movable barrier operator.

A movable barrier operator is also “prepared to initiate selective automated movement” of a movable barrier when the operator is presently engaged in a conditional multi-step process that is, taken as a whole, a process that will, by design and intent, effect such automated movement of the movable barrier. One example in this regard would be a multi-step automated barrier closure process that provides for closing the barrier by: (1) providing a visual and/or aural warning alert in the vicinity of the movable barrier to alert persons in the area of impending movement of the movable barrier for some period of time such as five seconds, ten seconds, or the like; and (2) effecting automated closure of the movable barrier at the conclusion of this period of time. In such a case as this, it will be seen and understood that the provision of the imminent barrier movement alert is part and parcel of the automated barrier movement step itself and hence is reasonably taken into account when viewing the movable barrier operator as being prepared to initiate selective automated movement of the movable barrier.

Again, these teachings will accommodate attempting the detection of moving objects during times when the movable operator is, in fact, prepared to initiate selective imminent automated movement of the barrier. Indeed, it can be useful in at least some application settings to detect the presence of moving objects during such times (for example, during the aforementioned period of time when the impending movement alert is being provided). This process 100, however, will particularly provide for such detection at times other than when the movable barrier operator is actually prepared to initiate such selective imminent automated movement of the movable barrier.

As one non-limiting example in this regard, some movable barrier operators have an automated barrier closure capability. Such a capability permits a movable barrier operator to automatically close an opened movable barrier following expiration of some predetermined period of time such as five minutes. Such a capability, for example, can contribute to improved security, can facilitate the observance of local regulations or practice regarding closed garage doors, and so forth. This window of time that precedes such an automated closure of the movable barrier is specifically noted as representing a time when the movable barrier operator is not prepared to initiate selective imminent automated movement of the movable barrier. Instead, in such a case, such a time does not occur until the predetermined period of time has expired and the movable barrier operator has now begun its movable barrier closure actions.

Upon detecting the motion of such on object, this process 100 then provides for automatically modifying 102 near term automated movement options of the barrier (where this will be understood to refer to one or more such options). This reference to “near term” will be understood to refer to a relatively short window of time prior to when the movable barrier operator will, or could, next effect an automated barrier movement option. Accordingly, and as but one salient but non-limiting example in this regard, the five minute delay that a given movable barrier operator may observe between opening its movable barrier and effecting automatic closure of that movable barrier can comprise a near term automated movement option as regards that barrier.

These teachings will readily accommodate a variety of corresponding modifications to the movable barrier operator's automated movement options. As one example in this regard, this can comprise automatically halting present movement of the barrier. As another example in this regard, this can comprise reversing a present direction of movement for the movable barrier.

As noted above, these teachings can be employed in conjunction with a movable barrier operator that is capable of effecting automatic closure of an opened movable barrier in response to the passage of a requisite period of time. In such an application setting, this process 100 can comprise automatically modifying 102 near term automated movement options of the movable barrier by cancelling imminent movement of the barrier (such as, for example, the planned movement of the movable barrier upon the expiration of the aforementioned requisite period of time). By another approach, this can comprise postponing such imminent movement (by, for example, postponing a time-based automatically delayed closure of the movable barrier).

In this case, and if desired, this can optionally comprise postponing such imminent movement for some corresponding duration of time. By one approach, for example, this can comprise resetting the requisite period of time referred to above that is to precede an automated closure of the movable barrier following that movable barrier being placed into an opened position. To exemplify by way of example, and again without intending any specific limitations in this regard, when the movable barrier operator utilizes a five minute window before such an automated closure will occur, whenever the movable barrier operator detects a moving object during this five minute window of time the movable barrier operator can reset that countdown to begin afresh the five minute window. By this approach the monitored area must be free of detectable movement for five minutes before automated closure of the movable barrier is permitted.

These teachings will readily accommodate, of course, other possibilities in these regards. For example, this process 100 will accommodate automatically modifying 102 near term automated movement options of the movable barrier by automatically temporarily modifying (such as by postponing) planned movement of the movable barrier as was instigated by the reception of a remote control command from a wireless remote control transmitter (such as a hand-held remote control transmitter or a vehicle-mounted remote control transmitter as are known in the art).

As another example of the flexibility of these teachings, and referring now to FIG. 2, these teachings will optionally accommodate, upon detecting 101 the motion of an object, then automatically determining 201 a relative distance of that object from a given location. This given location can comprise, for example, the location of the movable object detector (or detectors) that serves to detect the object's motion. As one illustrative, non-limiting example in this regard, this step can comprise determining whether the object is moving at a distance of more than, say, two meters from the given location. (Those skilled in the art will recognize that other distances, both shorter and greater, can be readily accommodated with the precise distance depending, at least in part, upon the unique circumstances as tend to characterize a given application setting.)

This information regarding the relative distance of the moving object with respect to this given location can then serve to inform the aforementioned functionality regarding automatic modification of near term automated movement options for the movable barrier. As one illustrative example in this regard, when the moving object is determined to be relatively distant from the given location (such as, and to continue the illustrative example offered above, more than two meters from the given location) the aforementioned automatic modification of near term automated movement options can be carried out 202. When, however, such is not the case (meaning that the moving object that is moving is within two meters of the given location), this process can provide instead for not modifying 203 near term automated movement options of the movable barrier.

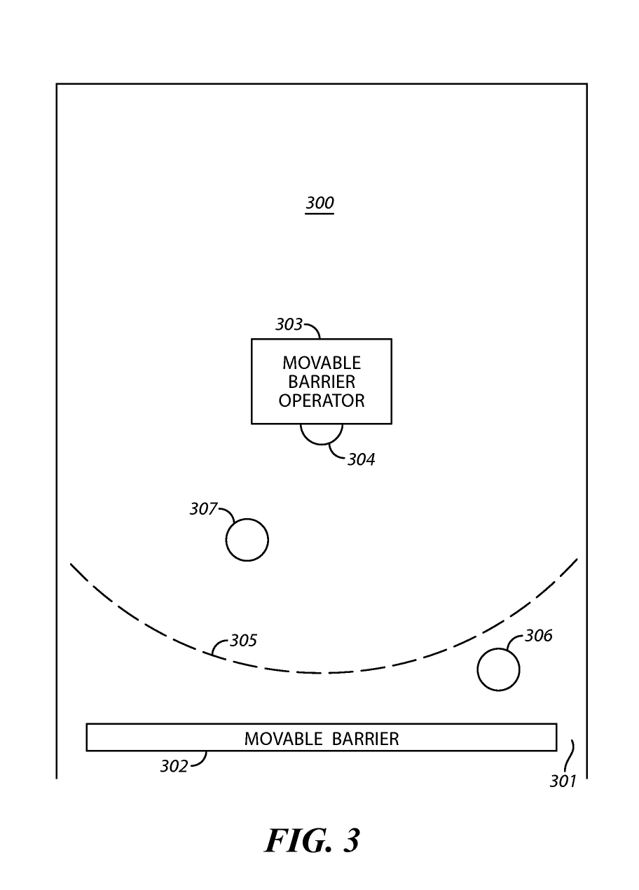

An illustrative example of such an accommodation will now be offered with reference to FIG. 3. In this illustrative example, a residential garage 300 has an opening 301 in which a movable barrier 302 (comprising a garage door) is able to be selectively automatically moved between a fully opened and a fully closed position by a movable barrier operator 303 that is mounted to the ceiling of the garage 300. This movable barrier operator 303 comprises a movable object detector 304 that is oriented to detect movement at least towards and beyond the front of the garage 300. In this example, the movable barrier operator 303 is configured and arranged to determine whether a given moving object is within the distance denoted by reference numeral 305 or disposed further away.

So configured, when a moving person 306 is located beyond this threshold distance, and hence is likely relatively close to the path of the movable barrier 302, automated delayed closure of the movable barrier 302 by the movable barrier operator 303 can be modifying as per these teachings in order to avoid a possibility that this person 306 might be engaged by the movable barrier 302 during such movement. Similarly, another person 307 who is moving within the aforementioned threshold distance 305 is less likely to encounter the movable barrier 302 during such automated movement. In this case, the movable barrier operator 303 can be configured as described to not automatically modify the near term movement options for the movable barrier which include the aforementioned automated delayed closure of the movable barrier.

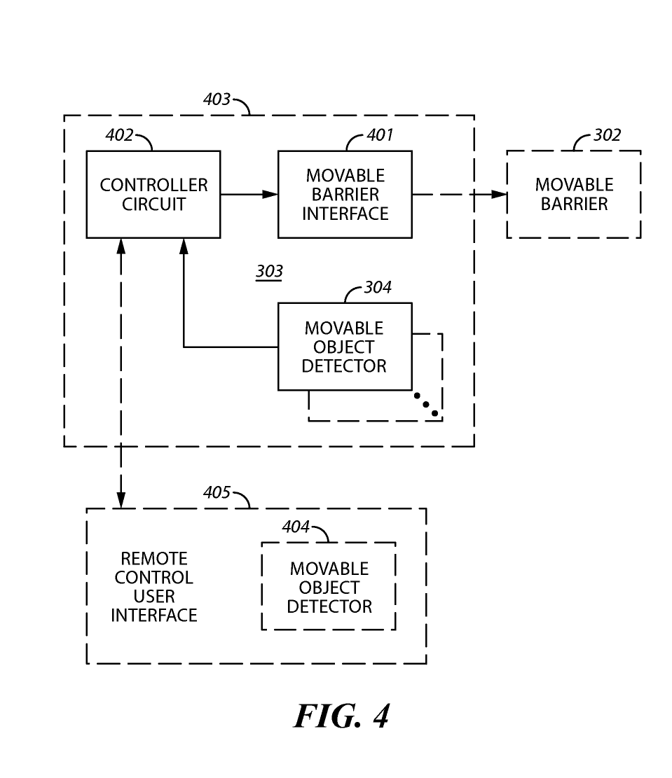

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform will now be provided.

In this illustrative example, the movable barrier operator 303 can comprise a movable barrier interface 401 that is configured and arranged to permit selective automated movement of a movable barrier 302. Various such movable barrier interfaces are known in the art and include various motors and corresponding drive trains such as chain drives, belt drives, and so forth. As these teachings are not overly sensitive to any particular selection in this regard, for the sake of brevity and the preservation of clarity, further elaboration in this regard will not be presented here.

The movable barrier operator 303 can also comprise the aforementioned movable object detector 304. As suggested by the illustration provided, this can comprise more than one such movable object detector if so desired. Various such detectors are known in the art. Examples include, but are not limited to, sound-based detectors (which employ, by one approach, ultrasonic reflections to detect movement), radio frequency carrier-based detectors, passive infrared (PIR)-based detectors and other vision-based detectors. Such detectors are well known in the art and require no further description here.

In this illustrative example the movable barrier operator 303 further comprises a controller circuit 402 that operably couples to the aforementioned movable barrier interface 401 and the moving object detector(s) 304 to facilitate the described control of the movable barrier as a function, at least in part, of information from the movable object detector 304. Those skilled in the art will recognize and appreciate that such a controller circuit can comprise a fixed-purpose hard-wired platform or can comprise a partially or wholly programmable platform such as a microprocessor/microcontroller of choice. All of these architectural options are well known and understood in the art and again require no further description here.

So configured, such a controller circuit 402 can be arranged (via, for example, corresponding programming as will be well understood by those skilled in the art) to carry out one or more of the steps, actions, and/or functionality as is set forth herein. This can comprise, for example, detecting the presence of a moving object (which may include also ascertaining a relative distance of that moving object as described herein) and then responsively automatically modifying near term automated movement options of the movable barrier 302. As noted, this can comprise, for example, halting or reversing present movement of the moving barrier, postponing a time-based automated action, and so forth.

Those skilled in the art will recognize and understand that such a movable barrier operator 303 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

By one approach, this movable barrier operator 303 can further comprise a housing 403 that serves to support at least a portion of the movable barrier interface 401 and the controller circuit 402. This housing 403 can also support, if desired, the moving object detector 304. These teachings will also accommodate, however, use of one or more moving object detectors 404 that are remotely disposed with respect to this housing 403 (either in combination with, or in lieu of, any moving object detector that might be integrally combined with the movable barrier operator 303). As used herein, this reference to being remotely disposed will be understood to refer to an installation configuration wherein no portion of the movable object detector 404 is contained within, or otherwise physically supported by, this housing 403.

In such a case, and only by way of example, the movable object detector 404 can be contained within or can otherwise comprise a part of a remote control user interface 405 that itself is operably coupled to the controller circuit 402. Such a remote control interface 405, for example, can comprise one or more push buttons in a housing that is configured and arranged to be mounted on a vertical surface such as the wall or doorway frame of a garage in which the movable barrier operator 303 is installed. Such push buttons can provide a mechanism, for example, to permit an end user to instruct the movable barrier operator 303 to move the movable barrier 302 to a different position.

So configured and arranged, these teachings permit a wide variety of automated movement options to be utilized with an increased sense and reality of security, safety, and convenience. Those skilled in the art will further recognize and appreciate that these teachings are readily deployed in conjunction with a wide variety of existing components and system configurations.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method comprising:
at a movable barrier operator that is configured and arranged to selectively control movement of a barrier:
detecting motion of an object at a time other than when prepared to initiate selective imminent automated movement of the barrier;
upon detecting the motion, automatically modifying near term automated movement options of the barrier.

2. The method of claim 1 wherein detecting motion of an object comprises detecting the motion using an integral motion detector.

3. The method of claim 1 wherein detecting motion of an object comprises detecting the motion using a remotely located motion detector.

4. The method of claim 3 wherein using a remotely located motion detector comprises using a remote control user interface that is configured and arranged to be mounted on a vertical surface and which comprises, in part, a motion detector.

5. The method of claim 1 wherein detecting motion of an object comprises detecting the motion using at least one of:
a passive infrared (PIR) detector;
a sound-based detector;
a radio frequency carrier-based detector.

6. The method of claim 1 wherein automatically modifying near term automated movement options of the barrier comprises halting present movement of the barrier.

7. The method of claim 1 wherein automatically modifying near term automated movement options of the barrier comprises reversing present movement of the barrier.

8. The method of claim 1 wherein automatically modifying near term automated movement options of the barrier comprises postponing imminent movement of the barrier.

9. The method of claim 8 wherein postponing imminent movement of the barrier comprises postponing a time-based automatically delayed closure of the barrier.

10. The method of claim 1 wherein automatically modifying near term automated movement options of the barrier comprises automatically temporarily modifying planned movement of the barrier as was instigated by reception of a remote control command from a wireless remote control transmitter.

11. The method of claim 10 wherein the wireless remote control transmitter comprises one of:
a hand-held remote control transmitter;
a vehicle-mounted remote control transmitter.

12. The method of claim 1 wherein detecting motion of an object comprises assessing a relative distance of the object from a given location.

13. The method of claim 12 wherein automatically modifying near term automated movement options of the barrier comprises automatically modifying near term automated movement options of the barrier as a function of the relative distance of the object from the given location.

14. The method of claim 13 wherein automatically modifying near term automated movement options of the barrier as a function of the relative distance of the object from the given location comprises:
automatically modifying near term automated movement options of the barrier when the object is relatively far from the given location;
not modifying near term automated movement options of the barrier when the object is relatively close to the given location.

15. A movable barrier operator comprising:
a movable barrier interface configured and arranged to permit selective automated movement of a movable barrier;
a moving object detector that is configured and arranged to detect movement of an object;
a controller circuit that is operably coupled to the movable barrier interface and the moving object detector and that is configured and arranged to, upon detecting the movement at a time other than when prepared to initiate selective imminent automated movement of the barrier, automatically modify near term automated movement options of the movable barrier.

16. The movable barrier operator of claim 15 further comprising:
a housing that supports at least a portion of the movable barrier interface and the controller circuit.

17. The movable barrier operator of claim 16 wherein the housing further supports the moving object detector.

18. The movable barrier operator of claim 16 wherein the moving object detector is remotely located with respect to the housing.

19. The movable barrier operator of claim 18 further comprising:
a remote control user interface that is configured and arranged to be mounted on a vertical surface and which is operably coupled to the controller circuit.

20. The movable barrier operator of claim 19 wherein the moving object detector comprises a part of the remote control user interface.

21. The movable barrier operator of claim 15 wherein the moving object detector comprises at least one of:
a passive infrared (PIR) detector;
a sound-based detector;
a radio frequency carrier-based detector.

22. The movable barrier operator of claim 15 wherein the controller circuit is configured and arranged to automatically modify near term automated movement options of the barrier by halting present movement of the barrier.

23. The movable barrier operator of claim 15 wherein the controller circuit is configured and arranged to automatically modify near term automated movement options of the barrier by reversing present movement of the barrier.

24. The movable barrier operator of claim 15 wherein the controller circuit is configured and arranged to automatically modify near term automated movement options of the barrier by postponing imminent movement of the barrier.

25. The movable barrier operator of claim 24 wherein the controller circuit is configured and arranged to postpone imminent movement of the barrier by postponing a time-based automatically delayed closure of the barrier.
